(19) United States
(12) Patent Application Publication
(10) Pub. No.: US 2017/0020094 A1
(43) Pub. Date: Jan. 26, 2017

(54) HYDROPONIC GROW CONTAINERS

(71) Applicant: Joseph C. Arterburn, Eugene, OR (US)

(72) Inventor: Joseph C. Arterburn, Eugene, OR (US)

(21) Appl. No.: 14/806,213

(22) Filed: Jul. 22, 2015

(51) Int. Cl. A01G 31/02; A01G 1/00; A01G 9/02

(52) U.S. Cl. CPC A01G 31/02; A01G 9/02; A01G 1/001

(57) ABSTRACT

Hydroponic grow containers and methods for growing plants in a hydroponic grow container are disclosed. The hydroponic grow containers may include a bottom wall having a perimeter, and at least one sidewall attached to, or formed with, the perimeter of the bottom wall. The bottom wall and the at least one sidewall may define an open-topped container having an interior. The hydroponic grow containers may additionally include an upper surface within the interior and attached to, or formed with, at least one of the bottom wall or at least one sidewall, and a lower surface within the interior and adjacent to the upper surface. The hydroponic grow containers may further include a plurality of ribs connected to, or formed with, the upper surface and configured to support a root mass of one or more plants. The upper surface may be configured to facilitate liquid flow towards the lower surface.

### BACKGROUND OF THE DISCLOSURE

Growing plants in water or in an aquatic based environment, without the use of soil, is commonly known as hydroponics. When a plant is grown in soil, the plant may expend energy searching for and extracting nutrients from the soil. This energy expended by the plant in searching and extracting nutrients from the soil may limit the growth potential of the plant. A hydroponic system helps deliver nutrients directly to the plant's roots via a water environment. With a hydroponic system, the plant may have more energy to use for its growth and development. Nutrients may be added as an aqueous solution and delivered to the plant's roots. A hydroponic system may be used to control the pH and nutrients a plant receives more easily than the traditional soil based method. Plants may grow more efficiently and produce larger and healthier plants with a hydroponic system.

There are a variety of hydroponic systems that may be used to deliver nutrients directly to a plant's roots via a water environment. For example, an ebb and flow system (or flood and drain system) may involve flooding the roots with nutrient solution for a desired length of time, and then draining the solution. The process is repeated as necessary. The ebb and flow system may include a grow tray to hold the plants and roots, and a separate container for a reservoir to hold and receive the drained solution. Another example of a hydroponic system is a drip system. The drip system may involve constant or intermittently dripping of nutrient solution on each plant and allowing any excess solution to drain or collect in a reservoir. Other examples may include an aeroponic, wick, water culture, and/or nutrient film technique systems. Hydroponic systems also may include an inert medium that is porous, such as pumice, gravel, sand, vermiculite, etc. The inert medium may be used to help support the weight of a plant and/or a plant's roots. Deciding which hydroponic system or combination of hydroponic systems to use may depend on the type of plant.

Although using a hydroponic system to grow plants may result in larger and healthier plants, finding or constructing the basic components of a hydroponic system may be challenging to find or build. Furthermore, although there are a variety of hydroponic systems that may be used to grow plants in a water based environment, one type of hydroponic system may require a different structure, setup, and/or parts than that of another type of hydroponic system. Therefore, depending on the type of plant(s) one decides to grow, multiple hydroponic system setups may need to be purchased and/or assembled.

### SUMMARY OF THE DISCLOSURE

Some embodiments provide a hydroponic grow container. In some embodiments, the hydroponic grow container may include a bottom wall having a perimeter, and at least one sidewall attached to, or formed with, the perimeter of the bottom wall. The bottom wall and the at least one sidewall may define an open-topped container having an interior. The hydroponic grow container may additionally include an upper surface within the interior and attached to, or formed with, at least one of the bottom wall or at least one sidewall, and a lower surface within the interior and adjacent to the upper surface. The hydroponic grow container may further include a plurality of ribs connected to, or formed with, the upper surface and configured to support a root mass of one or more plants. The upper surface may be configured to facilitate liquid flow towards the lower surface.

Some embodiments provide a method for growing plants in a hydroponic grow container. The hydroponic grow container may include a bottom wall having a perimeter, and at least one sidewall attached to, or formed with, the perimeter of the bottom wall. The bottom wall and the at least one sidewall may define an open-topped container having an interior. The hydroponic grow container may additionally include an upper surface within the interior and attached to, or formed with, at least one of the bottom wall or at least one sidewall, and a lower surface within the interior and adjacent to the upper surface. The hydroponic grow container may further include a plurality of ribs connected to, or formed with, the upper surface and configured to support a root mass of one or more plants. The upper surface may be configured to facilitate liquid flow towards the lower surface. In some embodiments, the method may include placing a root mass of one or more plants on at least a portion of the plurality of ribs, and drilling a first hole in the lower surface. The method may additionally include drilling a second hole in the at least one side wall of the container, and adding one or more liquids in the interior. The method may further include draining the one or more liquids through the first hole.

### BRIEF DESCRIPTION OF THE DRAWINGS

FIG. 1 is a schematic view of an example of a hydroponic grow container.

FIG. 2 is a schematic view of an example of the container of FIG. 1

FIG. 3 is a schematic view of another example of the container of FIG. 1.

FIG. 4 is an isometric view of an example of the container of FIG. 1.

FIG. 5 is an isometric view of the container of FIG. 4, showing interior components.

FIG. 6 is a top view of the container of FIG. 4.

FIG. 7 is a sectional view of the container of FIG. 4, taken along lines 7-7 in FIG. 6.

FIG. 8 is a sectional view of the container of FIG. 4 taken along lines 8-8 in FIG. 6.

FIG. 9 is a sectional view of the container of FIG. 4 taken along lines 9-9 in FIG. 6.

FIG. 10 is a flowchart illustrating a method for growing plants in a hydroponic grow container.

### DETAILED DESCRIPTION OF THE DISCLOSURE

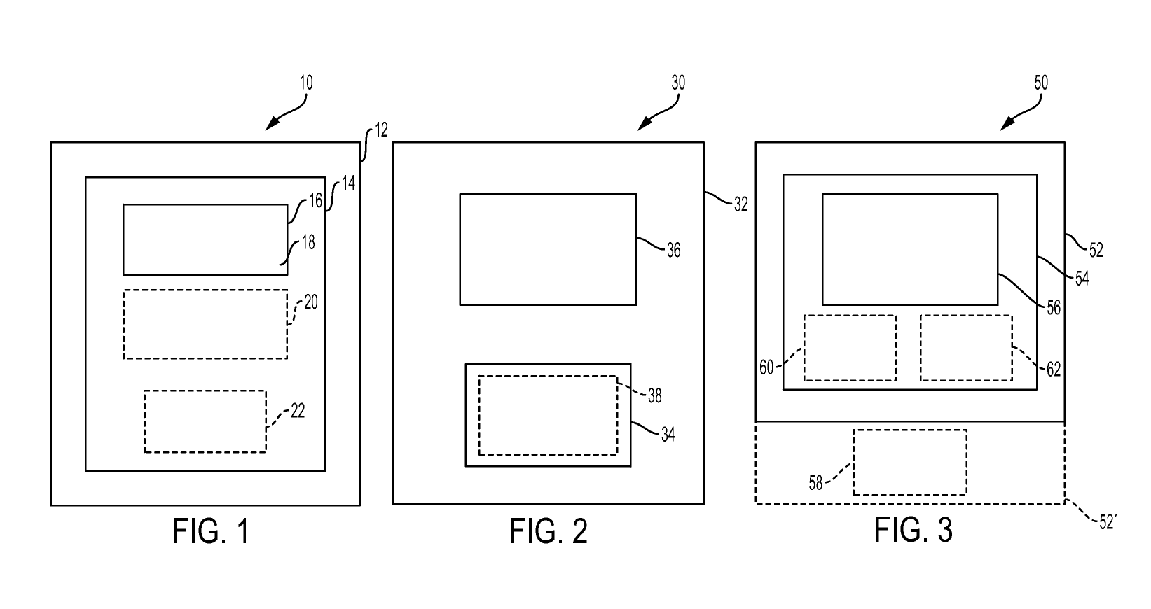

FIG. 1 shows an example of a hydroponic grow container 10. Container 10 may include any suitable structure configured to support a water based environment for one or more plants. FIG. 1 portrays a generally rectangular-shaped container that has, for example, about a 13-gallon capacity, but other shapes or dimensions may be appropriate, such as circular, square, etc., and/or 8-gallon, 10-gallon, etc. Container 10 may be made of one or more suitable materials, including plastic, glass, ceramic, or wood, among others.

Container 10 may include any suitable structure configured to support and/or facilitate the growth of one or more plants in a hydroponic and/or water based environment. For example, container 10 may include a housing 12, a drainage assembly 14, and a support assembly 16. Housing 12 may include any suitable structure configured to enclose and/or contain one or more components of container 10. For example, housing 12 may include at least one wall, panel, partition, screen, and/or barrier configured to enclose and/or contain one or more components of container 10. In some examples, at least one wall, panel, partition, screen, and/or barrier may be configured to allow a user to selectively open and/or remove the wall, panel, partition, screen, and/or barrier. In other examples, the housing may enclose and/or contain more or less of the other components of container 10 (see, for example, FIG. 3). Housing 12 may be configured to receive and/or hold one or more liquids, including water, nutrient solutions, liquid fertilizers, and/or any suitable combination(s).

Drainage assembly 14 may be attached to, or formed with, one or more components of container 10, and may include any suitable structure configured to facilitate and/or direct liquid flow to, from, and/or within one or more components of container 10. For example, drainage assembly 14 may include at least one sloped or angled surface configured to facilitate the liquid flow from at least one portion to another portion or portions of container 10. This configuration may help limit stagnant water. In some examples, the sloped or angled surface may be configured to facilitate the speed and/or force of the liquid flow. Alternatively, or additionally, drainage assembly 14 may include a reservoir configured to collect and/or retain liquids.

Drainage assembly 14 may include one or more orifices (not shown) configured to allow liquid to pass through. The orifice(s) may be provide with container 10 or may be created by a user of the container. In some examples, the orifice may be configured to receive a hose or a tube, and form a liquid tight seal between the orifice and the hose or tubing. In other examples, the orifice may be configured to receive a spray mister, an aeroponic mister, or the like. Alternatively, or additionally, the orifice may be configured to form a liquid tight seal with a removable plug or stopper.

Support assembly 16 may include any suitable structure configured to support and/or secure one or more plants and/or roots (or root masses). For example, support assembly 16 may include one or more ribs, fins, projections, ridges, nets, mesh, recesses, apertures, openings, grooves, or teeth, among others. Support assembly 16 may be attached to, or formed with, one or more components of container 10. In some examples, support assembly 16 may be configured to be any suitable shape and orientation to facilitate and/or support one or more plants and/or roots. Additionally, or alternatively, support assembly 16 may be configured to limit the plants and/or roots from spreading to and/or within one or more components of container 10.

Support assembly 16 may, for example, include a first support assembly 18. In some examples, support assembly 16 may also include a second support assembly 20. The first and/or second support assembly may include one or more of the above described structures. In some examples, the first and second support assemblies may include the same type or types of structures. In other examples, the first and second support assemblies may include different types of structures. For example, the first support assembly may include one or more ribs, and the second support assembly may include mesh extending over one or more apertures. Additionally, or alternatively, each support assembly may be configured to support different sizes and/or types of plants and roots. Although support assembly 16 is shown to include first support assembly 18, and in some examples, second support assembly 20, the support assembly may include additional support assemblies, such as third, fourth, and/or fifth support assemblies.

In some examples, container 10 may include a receptacle assembly 22, which may include any suitable structure configured to receive and/or hold an air stone, a pump, and/or other similar structures. Receptacle assembly 22 may be attached to, or formed with, one or more components of container 10, such as housing 12 and/or drainage assembly 14. The receptacle assembly may be positioned in any suitable portion(s) of the container. Although container 10 is shown to include a single receptacle assembly in some examples, container 10 may include additional receptacle assemblies, such as a second, third, and/or fourth assemblies (see, for example, FIG. 3).

FIGS. 2-3 are additional examples of container 10, which are generally indicated at 30 and 50 respectively. Unless explicitly stated, containers 30 and 50 may include one or more components of the other containers described in the present disclosure. Container 30 may include a housing 32, a drainage assembly 34, a support assembly 36, and/or a receptacle assembly 38. Support assembly 36 may be attached to, or formed with housing 32. Drainage assembly 34 may be adjacent to support assembly 36. In some examples, receptacle assembly 38 may be attached to, or formed with, drainage assembly 34.

Container 50 may include a housing 52, a drainage assembly 54, a first support assembly 56, a second support assembly 58, a first receptacle assembly 60, and/or a second receptacle assembly 62. Second support assembly 58 may be external to housing 52. In other examples, the housing may contain or partially contain second support assembly 58, as generally designated at 52′. Although container 50 portrays second support assembly 58 external to housing 52, additional components of container 50 may be external to housing 52.

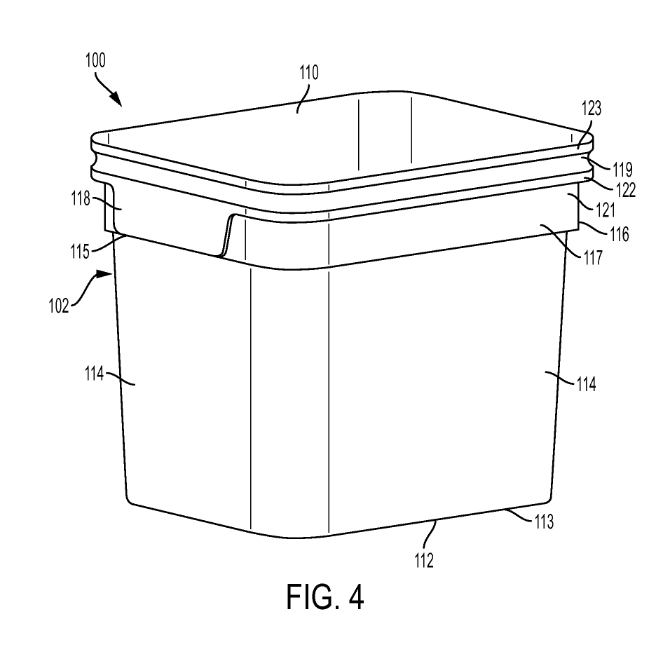

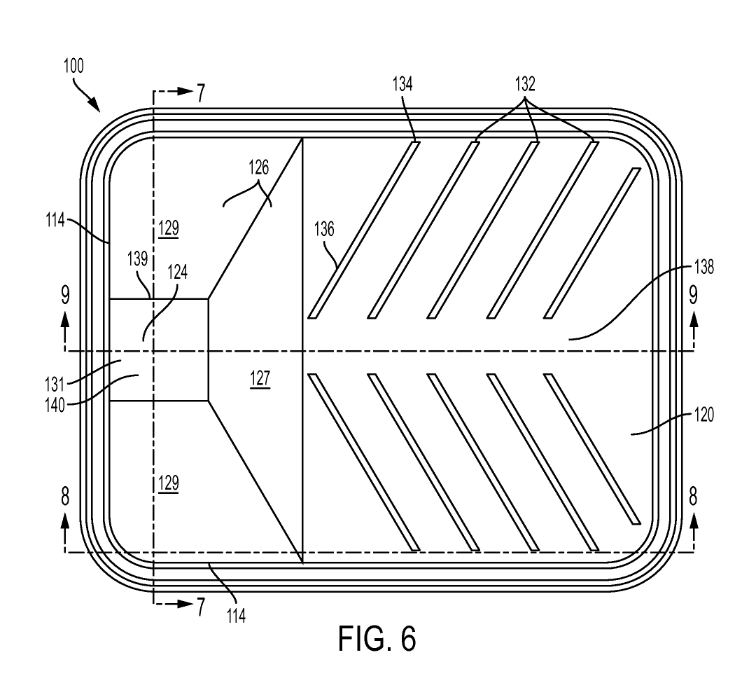

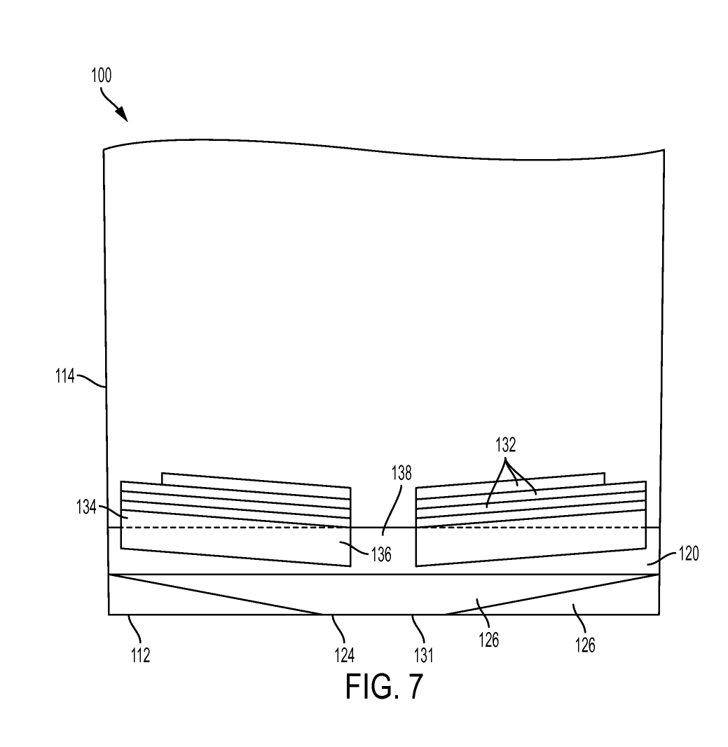

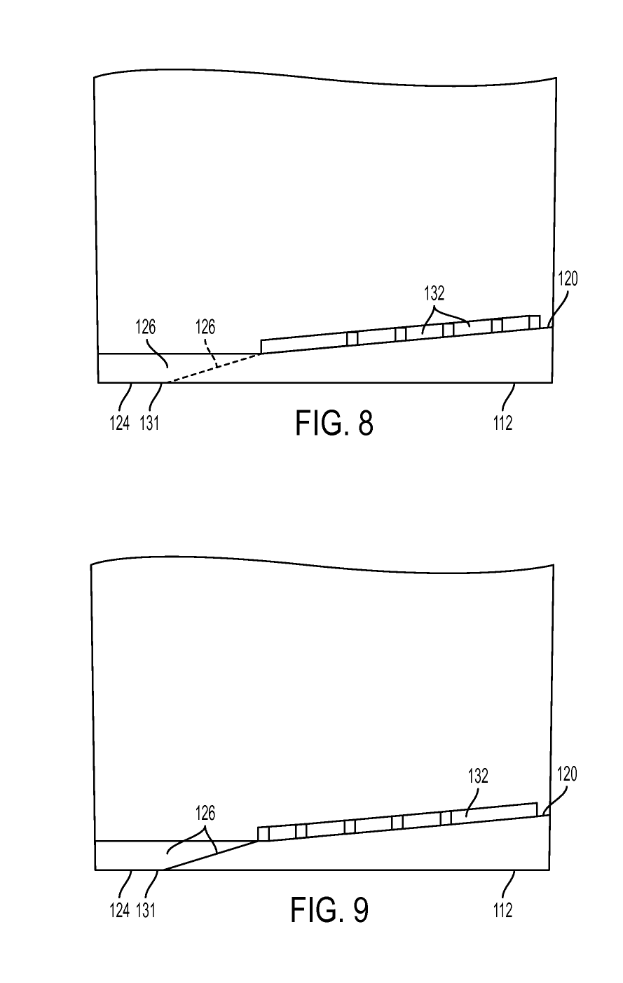

FIGS. 4-9 show another example of container 10, which is generally designated at 100. Unless explicitly stated, container 100 may include one or more components of the other containers described in the present disclosure. Container 100 may include a housing 102, a drainage assembly 106, a support assembly 104, and a receptacle assembly 108.

Housing 102 may include a bottom wall 112 and at least one side wall 114. Housing 102 may be any suitable shape and/or dimension to support and/or contain one or more components of container 100. Bottom wall 112 may have a perimeter 113 that is attached to, or formed with one or more side walls 114. Side walls 114 may extend from the perimeter of the bottom wall and/or the bottom wall defining an opening 110. Opening 110 may be any suitable shape and/or dimension to facilitate access to one or more components of container 100.

As shown in FIG. 4, a band 116 may be disposed circumferentially around an upper portion 115 of side walls 114. In other examples, the band may be any suitable shape and/or dimension depending on the shape and dimension of housing 102. Band 116 may be configured to facilitate stacking of one or more containers 100. Band 116 may include at least one handle 118 disposed on an exterior side 117 of band 116. Handle 118 may be configured to allow a user to hold and/or lift container 100. Band 116 may have a lower rim 122 and an upper rim 123 disposed on an upper portion 121 of band 116. Lower rim 122 and upper rim 123 may define a groove 119. Lower rim 122 and/or upper rim 123 may be configured to receive a lid or top (not shown). Groove 119 may be configured to engage with a lid or top and may be configured to seal and/or lock the lid or top to side walls 114. Lower rim 122 and/or upper rim 123 may be attached to, or formed with handle 118.

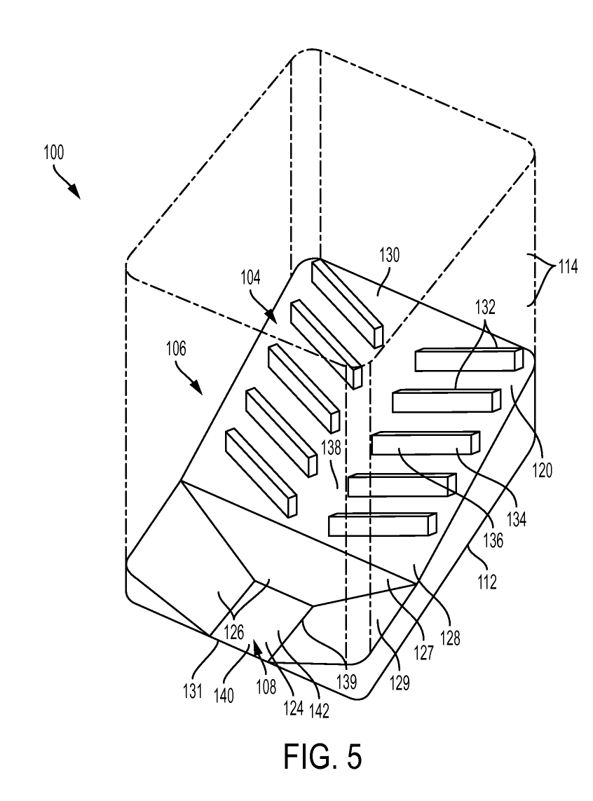

Drainage assembly 106 may include at least one upper surface 120, at least one middle surface 126, and at least one lower surface 124. Upper surface 120 may be attached to, or formed with bottom wall 112 and/or at least one of side walls 114. As shown in FIG. 5, upper surface 120 may be attached to, or formed with, bottom wall 112, three walls of side walls 114, and middle surface 126. In other examples, upper surface 120 may be attached to, or formed with, lower surface 124. Upper surface 120 may include an upper portion 130 and a lower portion 128. Upper surface 120 may be any suitable shape and/or dimension to facilitate liquid flow from the upper surface to the lower surface. Upper surface 120 may be sloped downward towards the lower surface to allow liquid to flow towards the lower surface. The upper surface may have any suitable slope angle to facilitate liquid flow. For example, the upper surface may be sloped about 15 degrees relative to bottom wall 112. This slope angle may help liquid to drain off the roots and limit the roots from growing towards the lower surface. In other examples, the upper surface may have any suitable angle slope to facilitate liquid flow and/or liquid flow rate.

Middle surface 126 may be attached to, or formed with bottom wall 112 and/or at least one of side walls 114. As shown in FIG. 5, middle surface 126 may include a middle portion 127 and two lateral portions 129. Middle portion 127 may extend between lower portion 128 of upper surface 120 and lower surface 124. Lateral portions 129 may extend between at least one side wall 114 and lower surface 124. The middle portion and the lateral portions may be in any suitable configuration to facilitate liquid flow to the lower surface. In some examples, the lateral portions may extend between lower portion 128 of upper surface 120 and lower surface 124. In other examples, middle surface 126 may include more or less portions.

Middle surface 126 may be any suitable shape and/or dimension to facilitate liquid flow from upper surface 120 to lower surface 124. Middle surface 126 may be sloped downward towards the lower surface to allow liquid to flow towards the lower surface. The middle surface may have any suitable slope angle to facilitate liquid flow. In some examples, the middle surface may be sloped about 22 degrees relative to bottom wall 112. In other examples, the middle surface may have a larger or smaller sloped angle depending on the intended flow rate of liquid. For example, middle surface(s) 126 may have a 90 degree angle relative to bottom wall 112. In some examples, middle portion 127 and lateral portions 129 may have the same sloped angle. In other examples, the middle portion and lateral portions may have different sloped angles.

Lower surface 124 may be adjacent the upper surface within the interior of the container. As shown in FIGS. 5-9, lower surface 124 may be at least a portion of an internal surface 131 of bottom wall 112. In some examples, lower surface 124 may be attached to, or formed with bottom wall 112 or at least one of side walls 114. In other examples, lower surface 124 may at least substantially be formed as a unitary structure with bottom wall 112.

Lower surface 124 may be any suitable shape and/or dimension to receive and/or collect liquids. For example, lower surface 124 may be flat. In other examples, the lower surface may be sloped, undulating, convex, or irregular, among others. Although lower surface 124 is shown to have a square shape, lower surface 124 may have any suitable shape, including rectangular, circular, oval, or triangular, among others. Lower surface 124 may be any suitable size to facilitate receiving and/or collecting of liquids. In some examples, the lower surface may have an area of approximately 2.75 inches. In other examples, the lower surface may have an area more or less than 2.75 inches.

Although drainage assembly 106 is shown to include upper surface 120, middle surface 126, and lower surface 124, container 100 may include more or less surfaces. For example, drainage assembly 106 may include an upper surface and a middle surface, and no lower surface. In other examples, drainage assembly 106 may include an upper surface, a middle surface, a lower surface, and at least one lateral surface.

Lower surface 124 may include a reservoir 140 configured to collect and/or retain liquids. In some examples, at least one side wall 114 and middle surfaces 126 may define reservoir 140 therebetween. In other words, the volume formed by at least one side wall and middle surfaces 126 may define the reservoir. In other examples, reservoir 140 may include one or more additional surfaces and/or structures (not shown) attached to, or formed with bottom wall 112, at least one of the side walls 114, upper surface 120, and/or lower surface 124.

As shown in FIGS. 5-9, a perimeter 139 may be formed with side walls 114 and middle surface 126. Perimeter 139 may define a bottom surface 142 of reservoir 140. Although bottom surface 142 is shown to have a square shape, bottom surface 142 may have any suitable shape, including rectangular, circular, oval, or triangular, among others. Bottom surface may be any suitable size to facilitate the collection and/or retaining of liquids. In some examples, the bottom surface may have an area of approximately 2.75 inches. In other examples, the bottom surface may have an area more or less than 2.75 inches. Bottom surface may be any suitable shape to facilitate collection and/or retaining liquids. In some examples, bottom surface 142 may be flat. In other examples, the bottom surface may be sloped, undulating, convex, or irregular, among others. Additionally, or alternatively, the bottom surface may include one or more orifices (not shown) configured to receive a tube or stopper and/or allow liquids to pass through.

Support assembly 104 may include a plurality of ribs 132 attached to, or formed with upper surface 120. Ribs 132 may be any suitable shape(s) and size(s) configured to support and/or secure one or more plants and/or roots. In some examples, the ribs may be generally rectangular, as shown in FIGS. 5-9. In other examples, the ribs may be curved, cylindrical, and/or triangular. Although ribs 132 is shown to be shaped and sized the same, the ribs may have different shapes and/or sizes. Additionally, although ribs 132 is shown to be attached to, or formed with upper surface 120, the ribs may be attached to, or formed with middle surface 126, lower surface 124, and/or any other components of container 100.

Ribs 132 may be in any suitable orientation(s) and/or positions. In some examples, the ribs may have a diagonal orientation relative to the upper surface, as shown in FIG. 5. In other examples, the ribs may alternatively have a vertical, horizontal, and/or other orientation. Moreover, although ribs 132 is shown to include two sets of ribs 132 arranged as mirror images of each other, the ribs may include one, three, four, or more sets of ribs, which may be in different arrangements and/or in different orientations. Additionally, although support assembly 104 is shown to include a total of ten ribs 132, the support assembly may include one through nine ribs or more than ten ribs. Additionally, or alternatively, ribs 132 may be configured to be removably attached.

Ribs 132 may be configured to facilitate liquid flow towards a channel 138 of the upper surface. For example, ribs 132 may include a diagonal orientation that directs flow towards the channel. Channel 138 may be shaped to facilitate liquid flow towards the lower surface. For example, channel 138 may be flat or may be concave-shaped. Channel 138 may, for example, be disposed between two sets of ribs 132, as shown in FIG. 5. In other examples, one or more channels 138 may be disposed between one or more ribs or sets of ribs. Channel 138 may extend from upper portion 130 to lower portion 128. In some examples, ribs 132 may include an inner portion 136 and an outer portion 134 oriented to facilitate liquid flow from the outer portion to the inner portion, and then to the channel. This configuration may help the liquid flow more evenly across and/or within the roots.

Additionally, or alternatively, ribs 132 may be configured to limit and/or hold the roots from spreading to lower surface 124. For example, the ribs may have a height of about 1 inch. This configuration may help to limit the roots from spreading to and clogging an orifice or drain in the lower surface. Additionally, in some examples, ribs 132 may have a diagonal orientation relative to the upper surface to help limit and/or hold the roots from spreading to the lower surface. In other examples, the ribs may be sized smaller or larger and have a different orientation. Additionally, ribs 132 may include other structures, such as projections, teeth, lattice, etc. to help limit and/or hold the roots from spreading to the lower surface.

Container 100 may include a receptacle assembly 108. In some examples, at least one side wall 114 and middle surfaces 126 may define receptacle assembly 108 therebetween. In other examples, receptacle assembly 108 may include one or more additional surfaces and/or structures that are attached to, or formed with lower surface 124 and/or bottom surface 142 of reservoir 140. Receptacle assembly 108 may include any suitable structure to receive, hold, and/or secure an air stone, a pump, or other similar structures.

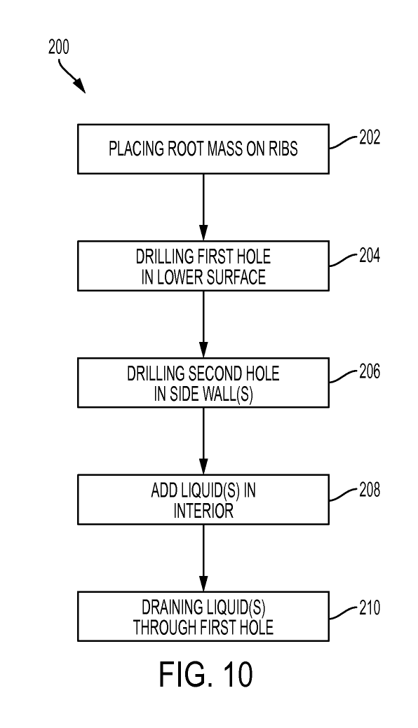

An example of a method for growing plants in a hydroponic grow container having an open top and an interior and including a bottom wall, at least one sidewall, an upper surface, a lower surface, and a plurality of ribs is shown in FIG. 10 and is generally indicated at 200. Although various steps of method 200 are described below and depicted in FIG. 10, the steps need not necessarily all be performed, and in some cases may be performed in a different order than the order shown.

Method 200 may include a step 202 of placing a root mass of one or more plants on at least a portion of the plurality of ribs. In some examples, the root mass may be placed and/or secured on one or more sets of ribs. In other examples, the root mass may be placed and/or secured on at least a portion of other structures and/or components of the container.

Method 200 may include a step 204 of drilling a first hole in the lower surface. Drilling may include removing a portion of the lower surface with a drill, saw, file, laser, etc. The hole may be drilled to any suitable size or shape, such as circular, oval, square, or triangular. In some examples, the hole may be shaped to receive a hose, plug, or stopper, among others. In other examples, additional holes may be drilled in the lower surface. Step 204 may be omitted if the container is provided with the first hole.

Method 200 may include a step 206 of drilling a second hole in at least one side wall. Drilling may include removing a portion of the at least one side wall with a drill, saw, file, laser, etc. The hole may be drilled to any suitable size or shape, such as circular, oval, square, or triangular. In some examples, the hole may be shaped to receive a hose, tube, among others. In other examples, additional holes may be drilled in at least one side wall. Step 206 may be omitted if the container is provided with the second hole.

Method 200 may include a step 208 of adding one or more liquids in the interior. Liquids may include water, nutrient solutions, or liquid fertilizers, among others. Adding one or more liquids may include pumping one or more liquids through the first hole. In some examples, pumping one or more liquids may pumping one or more liquids through the first hole at predetermined intervals. Additionally, or alternatively, adding one or more liquids may include spraying the root mass with one or more liquids. In some examples, spraying the root mass may include spraying the root mass with a bar or bank of spray misters. The bar or bank of spray misters may be inserted through the second hole and positioned within the interior of the container. In other examples, the bar or bank of spray misters may be additionally, or alternatively, inserted through other holes and/or the opening of the container. In some examples, spraying the root mass may include spraying the root mass with an air actuated mister, or similar structure. The air actuated mister, or similar structure, may be inserted through the first hole and positioned within the interior of the container. In some examples, adding one or more liquids may include dripping one or more liquids on the root mass. At least one drip line may be inserted through the second hole and/or the opening of the container.

Method 200 may include a step 210 of draining one or more liquids through the first hole. In some examples, draining one or more liquids may include passive draining. In other examples, draining may include pumping one or more liquids through the first hole. Additionally, in some examples, draining one or more liquids may include draining one or more liquids through additional holes, such as the second hole and/or other holes of the container.

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

1. A hydroponic grow container, comprising:
a bottom wall having a perimeter;
at least one sidewall attached to, or formed with, the perimeter of the bottom wall, the bottom wall and the at least one sidewall defining an open-topped container having an interior;
an upper surface within the interior and attached to, or formed with, at least one of the bottom wall or at least one sidewall;
a lower surface within the interior and adjacent to the upper surface; and
a plurality of ribs connected to, or formed with, the upper surface and configured to support a root mass of one or more plants, wherein the upper surface is configured to facilitate liquid flow towards the lower surface.

2. The container of claim 1, wherein the upper surface includes a channel, and the plurality of ribs is further configured to direct one or more liquids to flow towards the channel.

3. The container of claim 2, wherein the upper surface includes an upper portion and a lower portion downstream from the upper portion, and the channel extends from the upper portion to the lower portion.

4. The container of claim 2, wherein the plurality of ribs includes first and second sets of ribs with the channel being disposed between the first and second sets of ribs.

5. The container of claim 1, wherein at least one rib of the plurality of ribs is about 1 inch in height.

6. The container of claim 1, wherein the bottom wall includes an internal surface and the lower surface is a portion of the internal surface.

7. The container of claim 1, wherein the upper surface is sloped downward towards the lower surface.

8. The container of claim 7, wherein the upper surface is sloped about 15 degrees relative to the bottom wall.

9. The container of claim 1, further comprising at least one middle surface attached to, or formed with, at least one of the upper surface, the lower surface, or the at least one sidewall, and the at least one middle surface is configured to facilitate liquid flow from the upper surface towards the lower surface.

10. The container of claim 9, wherein the at least one middle surface is sloped downward towards the lower surface.

11. The container of claim 10, wherein the at least one middle surface is sloped about 22 degrees relative to the bottom wall.

12. The container of claim 9, wherein one or more sidewalls of the at least one side wall, the at least one middle surface, and the lower surface defines therebetween a reservoir configured to collect liquids.

13. The container of claim 1, wherein the lower surface is flat.

14. (canceled)

15. A method for growing plants in a hydroponic grow container, the hydroponic grow container includes:
a bottom wall having a perimeter;
at least one sidewall attached to, or formed with, the perimeter of the bottom wall, the bottom wall and the at least one sidewall defining an open-topped container having an interior;
an upper surface within the interior and attached to, or formed with, at least one of the bottom wall or at least one sidewall;
a lower surface within the interior and adjacent to the upper surface; and
a plurality of ribs connected to, or formed with, the upper surface and configured to support a root mass of one or more plants, wherein the upper surface is configured to facilitate liquid flow towards the lower surface,
the method comprising:
placing a root mass of one or more plants on at least a portion of the plurality of ribs;
drilling a first hole in the lower surface;
drilling a second hole in the at least one side wall of the container;
adding one or more liquids in the interior; and
draining the one or more liquids through the first hole.

16. The method of claim 15, wherein adding one or more liquids includes pumping one or more liquids through the first hole.

17. The method of claim 15, wherein pumping one or more liquids includes pumping one or more liquids through the first hole at predetermined intervals.

18. The method of claim 15, wherein adding one or more liquids in the container includes spraying the root mass with the one or more liquids.

19. The method of claim 16, wherein spraying the root mass includes inserting a bar or bank of spray misters through the second hole to position the bar or bank of spray misters within the interior, and spraying the root mass with the bar or bank of spray misters.

20. The method of claim 16, wherein spraying the root mass includes inserting an air actuated mister through the first hole to position the air actuated mister within the interior, and spraying the root mass with the air actuated mister.

21. The method of claim 15, wherein adding one or more liquids includes inserting at least one drip line through the second hole, and dripping the one or more liquids onto the root mass.
